(19) United States
(12) Patent Application Publication
(10) Pub. No.: US 2007/0191243 A1
(43) Pub. Date: Aug. 16, 2007

(54) REMOVAL OF SILICA BASED ETCH RESIDUE USING AQUEOUS CHEMISTRY

(75) Inventor: John C. Moore, Camarillo, CA (US)

Correspondence Address: ARTHUR J. PLANTAMURA;GENERAL CHEMICAL PERFORMANCE PRODUCTS LLC., 90 EAST HALSEY ROAD, PARSIPPANY, NJ, 07054, US

(73) Assignee: GENERAL CHEMICAL PERFORMANCE PRODUCTS, LLC, Parsippany, NJ (US)

(21) Appl. No.: 11/307,556

(22) Filed: Feb. 13, 2006

(51) Int. Cl. C11D 7/32

(52) U.S. Cl. 510/175

(57) ABSTRACT

Removal of silica-based etch residue is effected by use of an aqueous chemistry which eliminates hazard concerns in connection with electronic component fabrication tooling. The system employs a formulated product comprising a controlled level of ionized fluorine in a citrate buffer containing a dual surfactant system for etch residue penetration and rinsing. The combined system is proven to be ideal for Si-based etch residue dissolution and removal. The Si-residue removal rates have been characterized at specific buffered pH values and normal process conditions at times between 45 sec. to 3 min., and with those described being effectual at times of the order of 45 sec. or less when processed in a single-wafer tool. The product simplifies and reduces cost time and materials.

This invention relates to microelectronics manufacturing and, more particularly, to an aqueous cleaning composition for removing silicon-based etch residues.

### BACKGROUND OF THE INVENTION

The ITRS (International Technology Roadmap for Semiconductors) describes the manufacture of semiconductor interconnect devices to include copper/low-K materials. This new technology involves (Cu) wire interconnects separated by insulating material exhibiting a low dielectric (K) value. Many integration challenges exist with these more complex new materials and with interconnect schemes exceeding 12 layers wherein the final designs are even more advanced and according to the ITRS, having line widths well below 130 nanometers (nm).

The fabricating engineer must design manufacturing processes that insert metal lines and shunts between layers, all masked by lithography, cut by plasma etching, and filled by Cu electrochemical deposition (Cu ECD). As is common with any plasma etch process, residue exists on the feature's sidewalls and surfaces as illustrated for example by FIG. 1. After each etch and before Cu ECD, it is critical that all residue be removed. This residue is an amorphous mix of the same material present in the etched feature, namely silicon and interlayer dielectric (ILD), with photoresist by-products. Automated single-wafer cleaning tools plumbed with the cleaning chemistry are used for residue removal. These tools are equipped with sprayers to direct the chemistry application uniformly over the wafer. Following a given time period at a specific temperature, the applied chemistry is then rinsed away using deionized (DI) water within the same cleaning vessel.

In the past, removal required that the etch residue be dissolved away by chemical activity. Such prior art systems include organic mixtures, which contain aggressive additives such as amines and fluorinated agents to complex with constituents of the residue. These organic systems have proven to be beneficial in batch wafer tools. Solvent-based chemistries exhibit low surface tension, minimum foaming, and will aid in dispersion of particulates from surfaces due to the inherently non-conductive character of organic systems. Recent versions of these systems have included reducing agents or inhibitors as a means to reduce attack on the metal feature and aid in selectivity. However, many of these organic systems are used in batch wafer tools with limited success in removing silicon-based residue from features that are below 130 nm in size. Further, many of the known organic systems are toxic and generate a hazardous waste that is difficult to treat, adding to the overall cost of integration into the manufacturing process.

Many aqueous-based systems are commonly used in high-pressure tools, which mechanically diffuse through or under the residue and lift it away. The residue is lifted off with aggressive process chemistries, such as sulfuric-peroxide mixtures. The process may have to be repeated until the residue is gone, while risking corrosion to sensitive metals immediately adjacent to or underlying the residue. Sulfuric-peroxide systems are popular due to their aggressive oxidative nature toward organic residue, their ability to dissolve metals, and their effervescence quality which acts as a mechanical aid to prevent particle adhesion, pushing small debris towards the bulk medium where it is streamed away from the substrate and filtered. Although beneficial for aluminum-based devices, sulfuric-peroxide has limited success for Cu/Low-K applications. The high attack rate of sulfuric-peroxide to Cu is very hard to control, even in a single-wafer tool. Additionally, the mixture has limited removal success towards a silicon-rich residue. Therefore, for Cu/Low-K devices, sulfuric-peroxide mixtures typically result in low selectivity and are desirable for etch residue removal.

It is apparent, accordingly, that the availability of an aqueous-based system, which is safe for Cu/Low-K features, yet is effective in producing a thorough removal of the silicon-rich residue with subsequent particle removal and low-foaming benefits, would be most desirable.

### SUMMARY OF THE INVENTION

In accordance with the invention, I have discovered an aqueous-based blend of chemistries designed to remove post-etch residues which have incorporated silicon. The system comprises ionized fluorine in a weak acid buffer with a surfactant mix offering low surface tension and possessing suspension-aiding and low-foaming character. The buffer is established between citric acid and an organic amine. A desirable pH buffer target is between 4 and −5. This range allows for sufficient fluorine ionized from an ammonium fluoride source to complex with silicon present in the amorphous residue while minimizing attack to other silicon containing areas typically present as the native oxide or thermal oxidedeposited or grown for its dielectric properties. During complexation, the presence of copper is also removed by the chelating qualities of the citric acid and the amine. During removal, any debris or particles that may be swept from the surface is prevented from redeposition by a mixture of surface-active agents. This mixture contains a low molecular weight (MW) fluorinated surfactant in combination with a nonionic hydrocarbon mid-range MW surfactant. This surfactant system maintains a low surface tension while offering an emulsion-like consistency that maintains dispersion and low foaming. The aqueous system is designed for a single wafer tool whereby the chemistry is directed at approximately a 90° angle to the wafer surface by a jet that moves continually from the edge to the center while the wafer is spinning at a given rate per minute (rpm). Following the chemical exposure, delivery of the remover chemistry switches over to DI water and delivered in the same fashion, followed by a drying step that may include a hot nitrogen purge. Due to the small geometries involved, morphology inspection includes scanning electron microscopy (SEM), composition by energy dispersive X-ray analysis (EDX), and cross-section dimensional measurement by SEM methods using transmission electron microscopy (TEM).

### BRIEF DESCRIPTION OF THE DRAWING

FIG. 1 illustrates diagrammatically the lithography, etch, and clean process to produce features with a low-K dielectric stack comprising silicon carbide (SiC) barrier around interlayer dielectric (ILD) on top of thermal oxide (SiO₂) present on silicon.

FIG. 2 presents a diagram of the structure used to demonstrate the invention indicating SiLK® (a semiconductor dialectric resin by DOW Chemical Company) organic ILD with barrier SiC, silicon carbon nitride (SiCN), and capped with SiO₂, showing a minimum pattern size of 130 nm.

FIG. 3a is a sidewall area of the etched structure (5 μm) described in FIG. 2 while FIG. 3b is a spectra from an SEM/EDX analyses of the region shown in FIG. 3a.

FIG. 4a is a SEM photo of patterned wafer specimens with an immersion wafer exposure time of 45 seconds at pH 5.1.

FIG. 4b is a SEM photo of patterned wafer specimens with an immersion wafer exposure time of 180 seconds (3 min.) at pH 5.1.

FIG. 4c is a SEM photo of patterned wafer specimens with an immersion wafer exposure time of 45 seconds at pH 5.5.

FIG. 4d is a SEM photo of patterned wafer specimens with an immersion wafer exposure time of 180 seconds (3 min.) at pH 5.5.

FIG. 4e is a SEM photo of patterned wafer specimens with an immersion wafer exposure time of 45 seconds at pH 6.0.

FIG. 4f is a SEM photo of patterned wafer specimens with an immersion wafer exposure time of 180 seconds (3 min.) at pH 6.0.

FIG. 5a is a TEM photo of cross section analyses on patterned wafer exposure to the invention with approximately pH=5 at an immersion wafer exposure time of 45 seconds.

FIG. 5b is a TEM photos of cross section analyses on patterned wafer exposure to the invention with approximately pH=5 at an immersion wafer exposure time of 180 seconds (3 min.).

FIG. 6 is a graph showing surface tension changes upon mixing with DI water (rinsing) for the invention with different surfactants versus reference (no surfactant).

FIG. 7a is a SEM photo of patterned SiLK® organic ILD wafers of the kind described with reference to FIG. 2 prior to cleaning (no exposure, reference).

FIG. 7b is a SEM photo of patterned SiLK® organic ILD wafers of the kind described with reference to FIG. 2 indicating the results of wafer cleaning with the invention at an approximate pH=5 for time periods of 15-45 seconds using a single wafer spray tool.

FIG. 8 is a graph of electronic test results represented as serpentine line resistance on patterned SiLK® organic ILD wafers of the kind described with reference to the structure in FIG. 2 and the resistance curves represent wafers processed according to the invention at the conditions described in FIGS. 7a and 7b followed by metallization and resistance testing.

### DETAILED DESCRIPTION OF THE INVENTION

According to the invention, an aqueous system of ionized fluorine, citric acid-amine buffer, and a unique surface active agent mixture, penetrates amorphous post-etch polymer residues and complexes silica and copper while dispersing particulates which subsequently proceeds in a single wafer tool process until the area is completely clean and free of residue. The process is carried-out without the serious attack to adjacent metals and materials needed in the device stack, a key requirement in material selectivity. The chemistry applies to both inorganic silica-containing ILDs (i.e., conventional oxide, SiO₂) and to organic materials which offer ultra-low dielectric constants.

The novel system of the invention comprises a formulated product containing essentially (1) approximately 3-20 parts by weight of a weak organic acid exhibiting a pKa value, i.e., logarithm of acid dissociation constant, between 3-5 such as citric acid and (2) 1 -5 parts by weight of an inorganic amine conjugate salt of fluorine such as ammonium fluoride (AMF). Preferably, the formulated product also contains (3) sufficient amounts varying from 2-5 parts, depending upon the desired pH, of an organic amine as a buffering aid; and (4) a mixture of surfactants that include a nonionic fluorinated-based surfactant and a nonionic hydrocarbon-based surfactant, each in concentrations between 0.01-1 parts, all mixed with DI water added in amounts to meet the weight balance of the formulation. The amine is added to achieve the desired buffer pH, of between pH=5-6, and such that the system will produce ionizable fluorine to a level sufficient to complex with the silica present in the etch residue and thereby to effect break-up and removal without compromise to other silica containing materials present in the stack.

As with any semiconductor cleaning process, knowledge of the materials of construction will help design a successful chemistry that exhibits the needed performance and selectivity. Porous-type ILDs have lower-K values as compared to dense ILDs. Material porosity, which drives down the K-value, also absorbs residue and moisture during the cleaning process. Residue and moisture absorbed into the dielectric compromise its K-value. Further, many porous materials become brittle after processing and will lead to cracking, which is detrimental during chemical mechanical planarization (CMP) and packaging. Therefore, the efforts to implement small pore size, high hardness and modulus, and low coefficient of thermal expansion (CTE) of porous chemical vapor deposition (CVD) and spin-on inorganic ILDs, may be lost during integration after exposure to certain cleaning processes and result in poor K-values and mechanical degradation.

During integration, plasma etching processes involve resist that is broken down in the plasma and distributed over the wafer, most commonly along the vertical areas of the etch locations. This “redeposition” of resist is needed to ensure anisotropic etching, whereby the post-etch residue helps to focus the etch process vertically instead of horizontally. Anisotropic etching continues until a dissimilar material or metal (etch stop) is detected at the bottom of the topography, commonly used as an indicator for termination. When etching is completed, it is necessary that the wafer's etched devices are cleansed free of any post-etch residue to provide a clean substrate for subsequent processing.

Observing the ILD material will determine the expected etch residue composition, namely, thermal oxide-based ILDs produce silica and organic ILDs produce carbon. To confirm the residue composition, characterization may be required in order to tailor the chemical stripper and process. Residue may contain cross-linked resist, species from the substrate and the etch stop, and residual gas ions. Depending upon the materials to be stripped, the anisotropic benefits witnessed during etching, are sometimes lost during cleaning. This is because many cleaning processes which remove unwanted material also attack the wafer feature and damage the device. To achieve selectivity, high performance formulated chemistries with strong acids or alkalis require corrosion inhibitors. Complexing agents may also be used to selectively leach the inorganic species and to subsequently allow for bulk solvent penetration and dissolution. Without the bond-breaking and complexing capacity of the stripper, more aggressive or time consuming measures may be necessary, which may ultimately sacrifice selectivity.

ood screening practices for post-etch residue profiling along the trench side wall includes regional energy dispersive X-ray spectroscopy (EDS), also sometimes referred to as “EDX”. The technique is usually performed using an electron beam source from a SEM. This is achieved on large device topographies in a >60° tilt by directing the electron beam from top to bottom and receiving material composition information for each region. Although the electron beam from a SEM will penetrate near 1 μm during a 90° analysis, tests have been conducted with a high-tilt apparatus to reduce substrate penetration and maximize the information present in the surface.

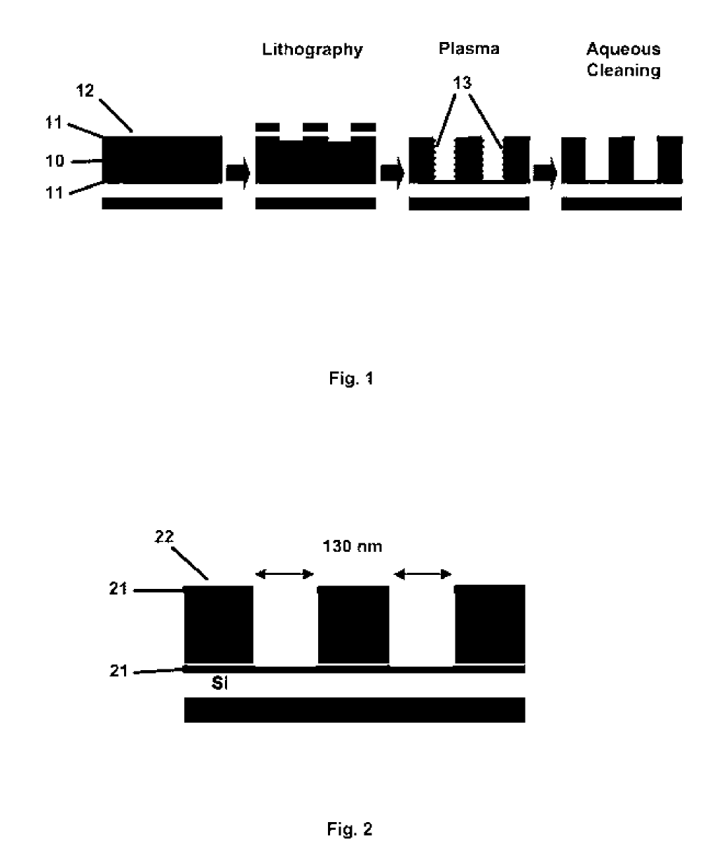

In current efforts, silica containing etch residue on organic ILD structures at 130 nm are achieved by a series of deposition, lithography, and etch processes. Patterned wafers containing Porous SiLK® ILD devices were manufactured by International Sematech in conjunction with Dow Chemical. As shown in FIG. 1, the SiLK® organic ILD 10 is spin-coated onto a hard etch stop material 11, such as silicon carbide (SiC), silicon carbide nitride (SiCN), and capped with thermal oxide (SiO₂) 12. These wafers were produced with no copper in the stack or substrate. Therefore, the stack contains only organic ILD and silicon-rich materials. Features produced on the wafers from etched trenches vary in size from 5 μm down to 130 nm. When used in processing copper lines, the barrier is on copper and plasma etching as shown in the third representation in the sequence shown in FIG. 1 which adds to the post etch residue 13. Shown in FIG. 2 is a drawing or diagram representation of the feature from the design specifications and comprises a structure used to demonstrate the invention indicating SiLK® organic ILD 20 with barrier SiC 21 and capped with SiO₂ 22, showing a minimum pattern size of 130 nm.

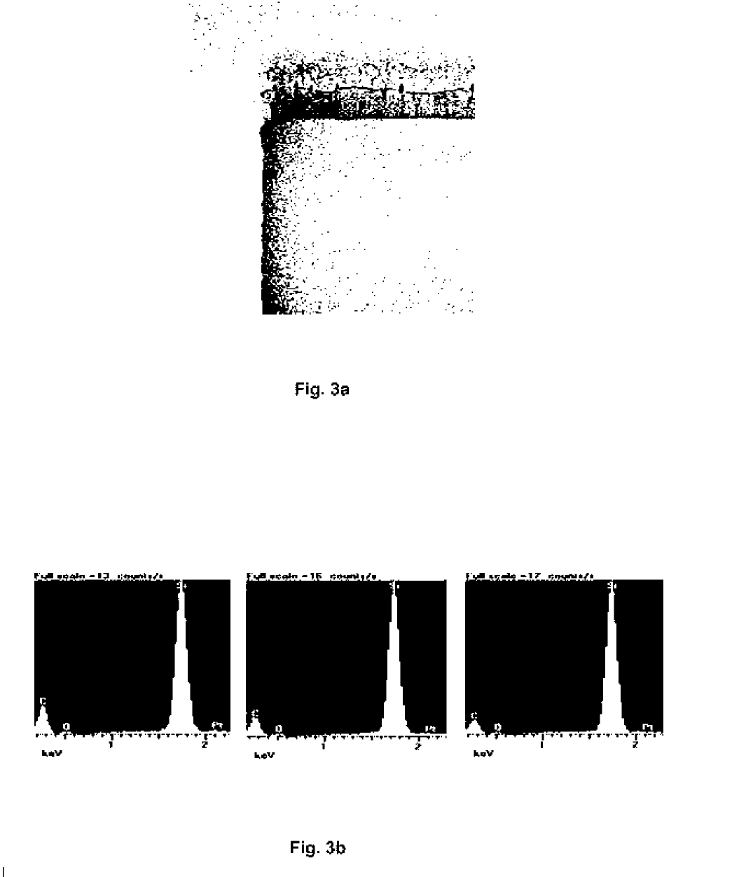

After plasma etching, the patterns commonly exhibit residue that must be removed prior to subsequent processing steps. Residue removal may proceed by exposure to the invention which leaches impregnated metal or oxide while exposing underlying organic matter, that can then be dissolved and/or rinsed away. The choice of chemistry depends upon the nature of the material, device structure, and tool design. Analytical methods are used for characterization to determine the composition of the etch residue. FIGS. 3a and 3b results show SEM-EDX analyses on a large area etched trench (5 μm) using a 60° angle along the sidewall for minimal substrate penetration and maximum surface specificity. The SEM analyses performed in this study was conducted with a Hitachi 4700 unit with EDS, following platinum (Pt) coating. The diagram shown in FIG. 3a is a large area etched structure (5 μm) of that described in FIG. 2 indicating the sidewall area that is being surveyed. The analysis is performed with a beam at 60° to the surface. The spectra of FIG. 3b shows results of SEM/EDX analyses on the region described in FIG. 3a. Results suggest silicon (main large peak in each spectra) is spread throughout the residue.

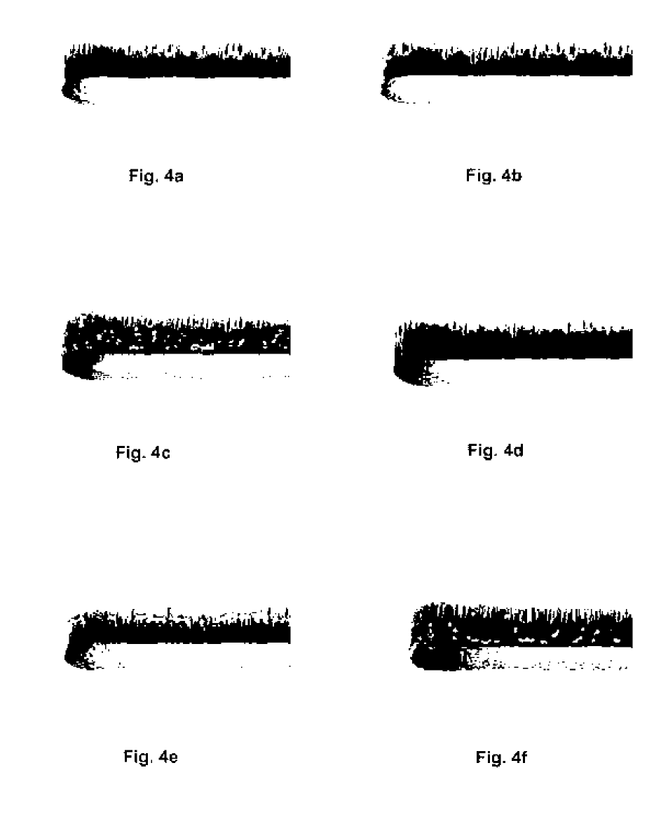

Tests were done in accordance with the invention prepared at different buffer pH values varying from pH 5.1-6 using citric acid (CAS #77-92-9) as the preferred organic acid with a pKa value between 3-5, ammonium fluoride (CAS #12125-01-8) as the inorganic fluorine salt, the organic amine as diglycolamine (aminoethoxyethanol, CAS #929-06-6), and the surfactant mix as Zonyl® FSO-100 for the nonionic fluorinated surfactant and Pluronic® 17B as the nonionic hydrocarbon surfactant (Zonyl® and Pluronic® are trademarks of E.I. Dupont De Nemours & Co., Inc. and BASF Corporation, respectively). The specimens tested and subject to inspection are the patterned wafers described and characterized by SEM/EDS in FIG. 3b. The experiment was conducted using immersion practices at room temperature at two exposure times, 45 sec. and 180 sec. (3 min.). These times were selected in an effort to model the short time conditions expected in a single-wafer cleaning tool. Following exposure, all wafers were rinsed in room temperature DI water and dried prior to inspection. Inspection was performed by SEM using the same methods as described earlier. The single wafer tool demonstration was conducted using best case conditions as demonstrated from the immersion studies. Results of the study are shown in FIGS. 4a-4f wherein SEM photos of patterned wafer specimens following different immersion exposure times to invention at varying pH adjustments are depicted. Note residue present on the sidewall surface shown in FIG. 4e corresponds to pH 6.0 and 45 seconds. At 45 seconds, the residue begins to break-up and remove at pH 5.5 (FIG. 4c) and is clean at pH 5.1 (FIG. 4a). For 180 sec. (3 min.), residue removal appears to begin at pH 6.0 (FIG. 4f) and is complete at pH 5.5 (FIG. 4d). However, for the 180 second (3 min.) period, there appears to be slight beveling character occurring at the hard mask top edge (see pH=5.1 and 5.5, FIGS. 4b and 4d).

Performance of the composition of the invention for removal of Si-rich post-etch residue it is observed is dependent on pH. Results indicate that the specimens came clean in 45 sec. (at pH 5.1 (FIG. 4a) and 180 sec. (3 min.) at pH=5.5 (FIG. 4d). For an exposure period of 45 sec., note the break-up and removal of residue beginning at pH=5.5 (FIG. 4c) and is completely clean at pH=5.1 (FIG. 4a). For an exposure time of 180 sec. (3 min.), the time appears to be shifted to higher pH values. Namely, at an exposure period of 180 sec. (3 min.), the break-up and removal of residue occurs at pH=6.0 (FIG. 4f) and is completely clean at pH=5.5 (FIG. 4d).

The results shown in FIGS. 4a-4f are consistent with ionization of fluorine and its complexing effects on silica containing residue. Lower pH values reflect a higher ionization of fluorine (higher concentration) and would expect a lower time to complex silica in the residue and result in complete removal. At 45 sec., pH=6.0 (FIG. 4e) there is no significant change whereas the longer time period 180 sec. (3 min.) for a given amount of ionized fluorine effects removal (FIG. 4f). A similar result applies to pH=5.5 where a 45 second exposure (FIG. 4c) is only beginning to remove the residue, however, at 180 sec. (3 min.) removal is complete (FIG. 4d). Had values above a pH=6 have been tested, they would have resulted in little or no change in residue appearance for the identified exposure times.

A characteristic beveling of the edge where the hard mask and side wall meet is observed in the exposure times of 180 sec. (3 min.) (FIGS. 4b, 4d and 4f), but does not appear as pronounced in the 45 second exposure (see FIGS. 4a, 4c, and 4e). Since the hard mask is composed of thermal oxide (see FIG. 2), it stands to reason that effects may exist from the ionized fluorine, especially for longer periods (i.e., 180sec.). In observing 180 sec. (3 min.) at pH 5.1 and 5.5 (FIGS. 4b and 4d, respectively), it is seen that a slight outline forming at the edge indicates that there may be some recession or attack occurring here. However, at the reduced exposure time of 45 sec. and pH 5.1 (FIG. 4a), the edge appears to be very straight with little or no hard mask etch (beveling). This beveling or edge attack requires cross-section analysis to determine the exact effects that exist.

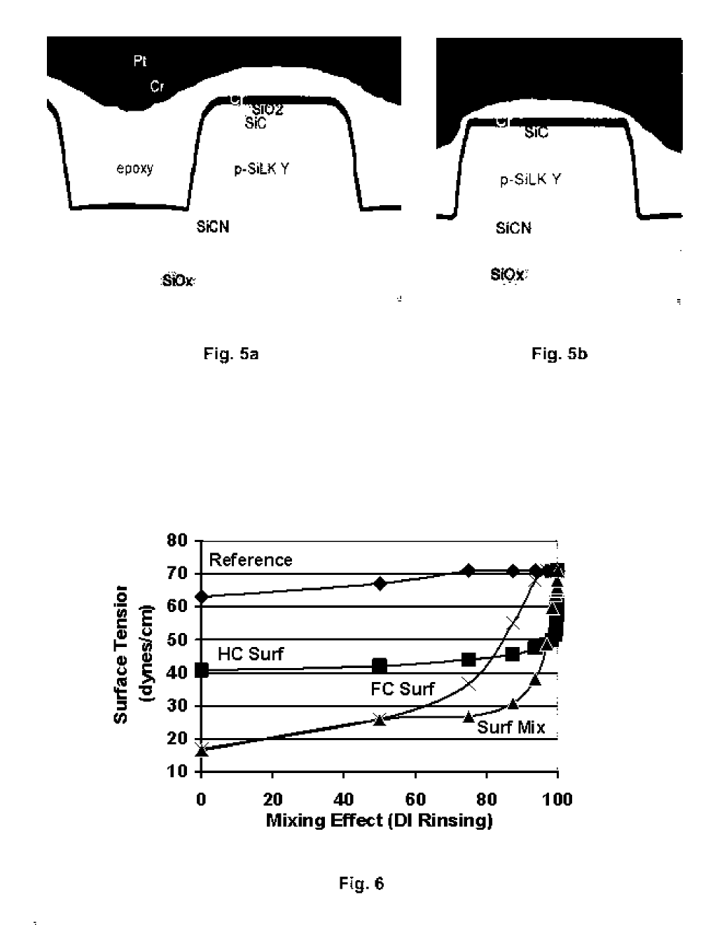

A closer look at the oxide mask condition upon exposure to the invention with an approximate pH=5 at times of 45 sec. and 180 sec. suggests that mask removal is occurring with time. TEM analysis is used to conclude this phenomena by cross-section sample preparation. A FEI Strata Dual-Beam 235 FIB-SEM (focused ion beam-scanning electron microscope) was used to prepare TEM samples. Samples were coated with approximately 300 Å of chromium (Cr) in a Denton Hi-Res 100 sputter coater, then coated with a thin layer of epoxy, and an additional 300 Å of Cr to planarize and protect the sample from ion beam damage and provide a conductive sample surface. TEM samples were prepared using the AutoTEM software built into the FIB-SEM. A 1 μm layer of platinum was deposited over the area where the sample was made via ion-assisted deposition using the gas injection system on the FIB-SEM as part of the AutoTEM routine. The slices were lifted out and placed on a conductive web and transferred to acquire TEM images using a JEOL 2010F field emission gun operated at an accelerating voltage 200 keV. Conventional TEM images were recorded using a Gatan multi-scan digital camera (Model MSC794). Results on prepared samples indicates that a 45 second exposure still maintains a 47 nm (approximately 500 Å) thickness of SiO₂, whereas at a 180 second exposure the SiO₂ layer appears to be completely gone, as shown by reference to FIGS. 5a and 5b. The TEM photos shown in FIG. 5a are cross section analyses for patterned wafer exposure produced according to the invention with approximately pH=5 at times of 45 sec. and 180 sec. (3 min.) as a determination of edge bevel (hard mask attack). The representations of FIGS. 5a and 5b indicate that the longer time exposure of 180 sec. (3 min.) (FIG. 5b) results in thermal oxide (hard mask) removal.

Performance of the invention has been demonstrated to be sensitive with pH and performs in the range of 5-5.5, depending upon the process time and potentially, the tool. The post-etch residue break-up and removal may involve particulate generation as observed in the SEM photos in FIGS. 4a-4f (pH=5.01, granular appearance). These particles may have a tendency to redeposit and cause irregularities in the device topography and directly cause failure in its performance. Small particles attached to a substrate surface are bound by capillary adhesion energy. This energy can be reduced by decreasing the energy at the solid-liquid interface (contact angle) through surface tension reduction. It is therefore important to ensure that good wetting (i.e., low surface tension and contact angle) is maintained throughout removal and rinsing, such that any particle generation is easily rinsed away. FIG. 6 depicts the change in surface tension of various surfactant additions to the invention formulation as it is mixed (rinsed) with DI water. Shown are surface tension changes upon mixing with different surfactants versus reference (no surfactant). Mixture of a hydrocarbon and fluorocarbon exhibits synergism, indicated by the best reduction in surface tension over the range of complete rinsing.

Reduction of both surface tension and contact angle can be achieved by mixing surface active agents. It is known that hydrocarbon surfactants (HC Surf) are effective at the liquid-solid interface (contact angle) while fluorocarbon surfactants (FC Surf) are best used for air-liquid interactions (surface tension). These systems were tested neat (reference) and in mixtures within the invention while mixing with DI water (rinsing effect). Care was taken for aqueous systems of high solids to prevent triggering the phenomena of salting out. The differences between HC Surf and FC Surf chemistries in a neat form is significant. The HC Surf offers a moderate plunge in surface tension yet maintains it over a wide range while the FC Surf exhibits a more dramatic reduction but is lost with dilution. Tests were performed by surface tension using a Fisher Scientific Tensiometer 21 with NBS standards. The best is achieved with mixtures of both (Surf Mix) to give good reduction over a prolonged mixing range to near complete rinsing with DI Water as illustrated by FIG. 6.

The invention is desired for use in spray tooling which are common to wafer fabrication areas. Chemistries which are successful in such tools must exhibit low foam character. Foaming capacity was tested on the surfactant mixture using Draves foam-height measurement techniques. The method involves a specific volume of analyte, normally 50 milliliters (ml), inserted into a 100 ml size graduated cylinder with cap. The cylinder is capped and shaken for a specific period of time, normally 15-30 sec., and immediately set onto a flat surface while observing the numeric gradations, which are superimposed onto the liquid. The measurement of foam height over the liquid level, in units of ml, are recorded within 5-10 sec. from shaking. The foam height may also be measured at increments of time extending from shaking, normally at 1 min. intervals. Since the interest in this invention is the level of foam generated in a spray tool, the foam height is measured within 5-10 sec. of shaking. Values of foam height for a range of surfactants and mixtures are reported in Table 1.

TABLE 1

| | Concentration | Foam Height |
|---|---|---|
| Surfactant | (% w/w) | (ml) |
| Zonyl ® FSO-100 | 0.01-0.05 | 5-10 |
| Plurofac ® SL-92 | 0.1-0.3 | 25-30 |
| Pluronic ® 17B | 0.1-0.3 | <2* |
| Zonyl ® FSO-100 & Pluronic ® 17B | 0.05-0.1 | <5 |

*Note:
Solution concentrations >0.1 exhibit emulsion character.

The data in FIG. 6 and in Table 1, it is observed that a mixture of surfactants Zonyl® FSO-100 and Pluronic® 17B will produce very low surface tension and exhibit low foam. The invention contains this mixture of fluorcarbon and hydrocarbon surfactants. The necessary qualities of low surface tension to facilitate particle removal are realized in a spray tool without the problems exhibited by excess foam.

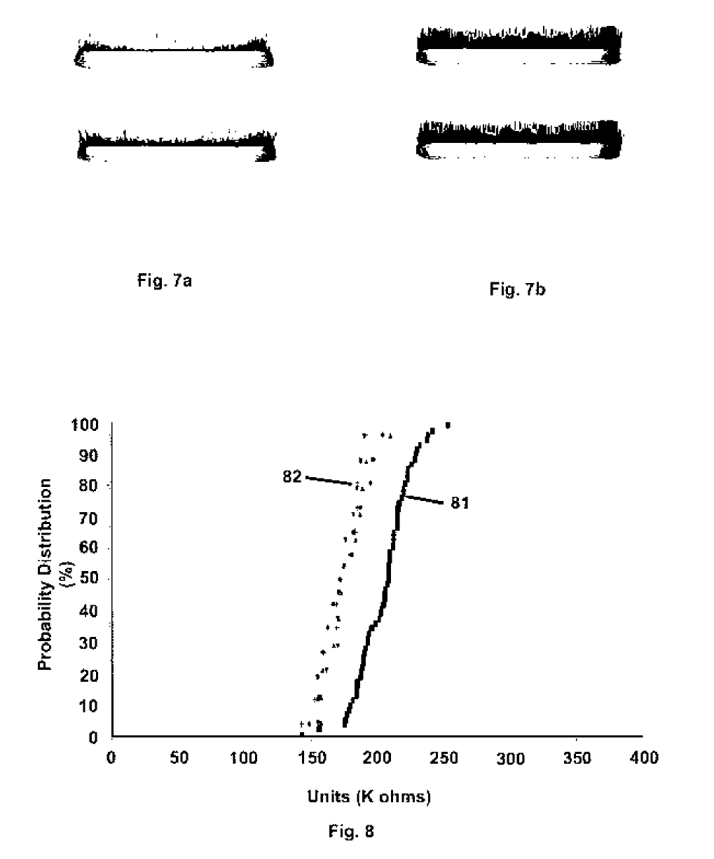

Patterned SiLK® ILD wafers were prepared for processing in an automated single-wafer spray tool. This tool is labeled as the Capsule™ single-wafer processing unit (Capsule™ is a registered trade mark of Semitool, Inc.). Wafers patterned with features down to 130 nm as described with reference to FIG. 2 are exposed according to the invention in a Capsule™ for 15-45 sec. followed by a DI water rinse. The results from this demonstration as observed by SEM photos indicate successful silica-based residue cleaning according to the invention at an approximate pH of 5.0±0.1 from geometries down to 130 nm SiLK® ILD patterned wafers. As depicted in FIG. 7a, the SEM photo indicates the wafer feature prior to cleaning (no exposure, reference). In FIG. 7.b, the SEM photo indicates the cleaned surface of the feature is free of residue and particles. These photos are consistent with that present in FIGS. 4a and 4e where the corresponding photo of a no-clean (reference) condition is indicated by the 45 second exposure at pH=6 (FIG. 4e), and the clean condition is shown by a 45 second immersion exposure at pH=5.1 (FIG. 4a).

Following full wafer process cleaning, metallization occurs and the wafers undergo electrical parametric testing. For the SiLK® ILD patterned wafers, subsequent processing and electrical testing was performed by International Sematech. Several electrical measurements were performed to include serpentine resistance, sheet resistance, stray capacitance, and bridging current. The same measurements were made on a non-cleaned (reference) wafer. FIG. 8 shows the serpentine resistance measurement for both the processed and unprocessed reference wafers. After cleaning with the invention and processing, the electrical tests indicate a reduction in resistance, which is consistent with a cleaning operation.

The unprocessed wafer electrical results (81) and the processed wafer electrical results (82) in FIG. 8 demonstrate that the processed wafer yields, on average, a 10% decrease in resistance relative to the reference (no clean) wafer. Reduction in resistance is consistent with sidewall polymer removal. Specifically, as the sidewall polymer residue is removed, the trench (line) width increases slightly which would result in an increase in conductivity and reduced line resistance. Leakage current (not shown) and capacitance data (not shown) are consistent with the trend indicated in FIG. 8, producing an improved electrical performance as a result of cleaning with the invention.

It is apparent from the foregoing that successful wafer processing is obtainable with the unique aqueous-based cleaning chemistry provided in accordance with the invention for removing silica-based post-etch residue from ILD stack features used in Cu/Low-K integration. The invention is effective in removing post-etch residue from patterned wafers containing features with SiLK® organic ILD and silica in process times at or below 45 sec. when using a single-wafer tool described by the Capsule™ module as manufactured by Semitool, Inc. Results from SEM, TEM, and electrical tests suggest residue is removed without sacrifice to device integrity.

Although the present invention has been described in terms of specific embodiments, various changes can be made, including varying the concentration of the chloride solution and the additives. Thus, the invention is only meant to be limited by the scope of the appended claims.

What is claimed is:

1. An aqueous-based composition for removing silica containing etch residue a from a sub-micron patterned inorganic substrate comprising a blend of:
(a) from about 3 to about 20 weight percent of a weak organic acid having a pKa value between 3-5; and
(b) about 1 to about 5 weight percent of an inorganic ionizable fluorine salt.

2. The composition of claim 1 wherein the fluorine salt is an inorganic amine conjugate fluorine salt.

3. The composition of claim 2 wherein the fluorine salt is ammonium fluoride.

4. The composition of claim 1 containing 2-5 parts by weight of an organic amine buffering aid and a mixture of about 0.01 to about 1.0 parts of each of a non-ionic fluorinated and a non-ionic based surfactant.

5. A liquid solvating composition of claim 1, which includes also from about 2 to about 5 weight percent of an organic amine, used to adjust the buffer to pH between 5-6.

6. The composition of claim 1 wherein (a) is present in amounts of about 5 to about 10 weight percent and (b) is present in amounts of about 1 to about 3 weight percent.

7. The composition of claim 1 wherein the weak acid is citric acid.

8. The composition of claim 1 wherein the fluorine agent is ammonium bifluoride.

9. The composition of claim 2 wherein the organic amine is diglycolamine.

10. In a method for removing silicon containing etch residue from an inorganic substrate the improvement characterized in that the etch residue to be removed is contacted with the solvating composition of claim 1 for a period of time effective to completely remove said etch residue.

11. In a method for removing silicon containing etch residue from an inorganic substrate the improvement characterized in that the etch residue to be removed is contacted with the solvating composition of claim 9 for a period of time effective to completely remove said etch residue.

12. The method of claim 10 wherein the inorganic substrate is a spinning wafer and the wafer surface is contacted with the solvating composition by directing the composition at approximately 90° to the wafer surface by a jet stream that moves from the edge to the center of the wafer.
